(19) United States
(12) Patent Application Publication
(10) Pub. No.: US 2014/0368051 A1
(43) Pub. Date: Dec. 18, 2014

(54) CORDLESS EXTENSION CORD

(71) Applicant: Theresa Kidd, Sikeston, MO (US)

(72) Inventor: Theresa Kidd, Sikeston, MO (US)

(21) Appl. No.: 14/305,474

(22) Filed: Jun. 16, 2014

Related U.S. Application Data
(60) Provisional application No. 61/835,474, filed on Jun. 14, 2013.

(51) Int. Cl. H02J 17/00

(52) U.S. Cl. CPC H02J 17/00
USPC 307/104

(57) ABSTRACT

A cordless extension cord for providing access to electrical power wirelessly to one or more corded electrical devices situated remotely from a power source. The cordless extension cord comprises a male plug and a female plug socket, wherein the male plug is configured to connect to a conventional power source and convert electrical energy into electromagnetic waves to be sent to the female plug socket and the female plug socket is configured to convert electromagnetic waves received from the male plug into electricity while physically engaged to conventional electrical plugs of electrical devices so as to provide such electricity through the conventional electrical plugs to the electrical devices. In this manner, the cordless extension cord allows electrical devices to receive electricity through their existing cord/plug structure without placement location being limited the length of the cord.

### CROSS REFERENCE TO RELATED APPLICATIONS

This application claims the benefit of co-pending U.S. provisional patent application Ser. No. 61/835,474 filed Jun. 14, 2013.

### BACKGROUND OF THE INVENTION

1. Field of the Invention

This invention relates generally to electrical components and, more particularly, to an apparatus which facilitates the delivery of electrical power from a power source to an electrical device wirelessly.

2. Description of the Prior Art

The delivery of electrical power from a power source to an electrical device through physical electrical wiring is well known. On a large scale, such can be observed in the delivery of electrical power from a power plant to a home, store, or office building through above ground or below ground electrical wires. On a smaller scale, many consumer devices which require electrical power have a power cord built in which is adapted to plug into a electrical socket, such as a wall jack, (to access electrical power which has been delivered to the house or building) to obtain access to and draw electrical power from the electrical power which has been delivered to the location in which the consumer device is in. In such a setup of a consumer or other electrically powered device using a plug to access power from a wall socket, it has long been contemplated that it may be desirable to locate the device in a place where its plug could not reach the wall socket. In that situation, the use of extension cords, which can be plugged into a wall socket and receive a plug from one or more other electrical devices so as to allow the electrical devices to access electrical power from the wall socket, is well known.

A problem which still exists, however, while conventional extension cords can be very handy, the length of the cord can form a dangerous tripping hazard over which people could fall and injure themselves. Moreover, when a plurality of extension cords are used at the same time or when a long extension cord is utilized, they often look very messy. Furthermore, extension cords can increase the risk of electrocution if the wires are not properly insulated and maintained. Thus, there remains a need for an apparatus which can extend the distance from a power source over which electrical power can be delivered to the cord of an electrical device without creating an added tripping hazard. It would be helpful for such an apparatus to increase the distance over which electricity could be provided while not creating a cluttered appearance, regardless of how many were in use at a given time. It would be additionally desirable for such an apparatus to reduce the risk of electrocution to users while remaining capable of delivering electricity to devices remote from the power source.

The Applicant's invention described herein provides for a cordless extension cord for supply electrical power wirelessly to one or more corded electrical devices situated remotely from a power source. The primary components of Applicant's cordless extension cord are a male plug configured to engage a conventional electrical socket and adapted to convert energy in the form of electricity to electromagnetic waves and a female plug socket adapted to receive and convert electromagnetic waves transmitted by the male plug into electricity and configured to supply said electricity to conventional electrical plugs. When in operation, the cordless extension cord facilitates the wireless delivery of electricity from a power source to the cord of an electrical device without the need for or introduction of any additional length of electrical cord. As a result, many of the limitations imposed by the structure of existing corded extension cords are removed.

### SUMMARY OF THE INVENTION

A cordless extension cord for providing access to electrical power to one or more corded electrical devices situated remotely from a power source. The cordless extension cord comprises a male plug and a female plug socket, wherein the male plug is configured to connect to a conventional power source, such as a conventional electrical socket and convert electrical energy into electromagnetic waves to be sent to the female plug socket and the female plug socket is configured to convert electromagnetic waves received from the male plug into electricity so as to provide such electricity to conventional electrical plugs engaged thereto. In this manner, the cordless extension cord allows electrical devices to receive electricity through their existing cord/plug structure without having to be placed in locations within the reach of their existing cord/plug structure or even of their existing cord/plug structure with an added corded extension cord.

The cordless extension cord is operated by first availing an electrical current to a male plug built in accordance with the present invention. This is often done by merely locating a desired conventional power source, such as an electrical socket, and plugging the male plug in. In such an instance, the male plug receives and accesses the electrical current from the electrical socket and converts the electrical current into electromagnetic waves. These electromagnetic waves are broadcast by the male plug so as to be received by a female plug socket built in accordance with the present invention.

Female plug sockets built in accordance with the present invention are designed to physically receive conventional cord/plug structures from electrical devices or appliances sought to be powered. The female plug socket is additionally configured to receive electromagnetic waves broadcast by a male plug built in accordance with the present invention. Upon receipt of electromagnetic waves, the female plug socket converts the waves to electrical current having the properties on which conventional electrical devices are already designed to run. As a result, when an electrical device desired to be powered is connected to the female plug socket by its conventional cord/plug structure, it accesses the electrical current availed by the female plug socket to operate in its conventional manner.

It is an object of this invention to provide an apparatus which can extend the distance from an electrical power source over which electricity can be delivered to the existing cord structure of an electrical device.

It is another object of this invention to provide an apparatus capable of increasing the distance over which electricity could be provided without creating an added tripping hazard.

It is yet another object of this invention to provide an apparatus capable of increasing the distance over which electricity could be provided while not creating a cluttered appearance regardless of how many were in use at a given time.

It is still another object of this invention to provide an apparatus capable of reducing the risk of electrocution to users while remaining capable of delivering electricity to devices remote from the power source.

These and other objects will be apparent to one of skill in the art.

### BRIEF DESCRIPTION OF THE DRAWINGS

FIG. 1 is a side elevational view of a male plug built in accordance with the preferred embodiment of the present invention.

FIG. 2 is a front elevational view of a female plug socket built in accordance with the preferred embodiment of the present invention.

FIG. 3 is a front elevational view of an alternate embodiment of a female plug socket built in accordance with the preferred embodiment of the present invention.

FIG. 4 is a front elevational view of another alternate embodiment of a female plug socket built in accordance with the preferred embodiment of the present invention.

### DETAILED DESCRIPTION OF THE INVENTION

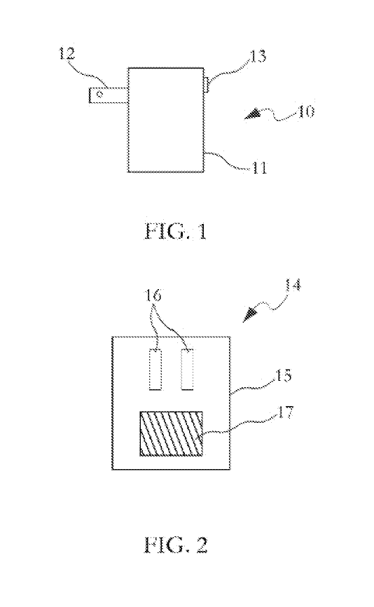

Referring now to the drawings and in particular FIG. 1, a male plug 10 of a cordless extension cord built in accordance with the preferred embodiment of the present invention is shown comprising a rigid body 11 having a set of electrical pins 12 and a metallic antenna 13 disposed on its exterior. The interior of the male plug 10 includes electrical wires disposed between the electrical pins 12 and an electricity to electromagnetic wave converter for carrying electrical current received at said pins 12 to said electromagnetic wave converter. The electromagnetic wave converter is additionally connected to said antenna 13 so as to allow the antenna to broadcast the waves generated by the electromagnetic wave converter.

Referring now to FIG. 2, a female plug socket 14 of a cordless extension cord built in accordance with the preferred embodiment of the present invention is shown comprising a rigid body 15 having a pair of electrical slots 16 configured to receive conventional electrical plugs and an electromagnetic receiver 17 for receiving electromagnetic waves transmitted by the antenna 13 of the male plug 10. On the interior of the female plug socket the receiver 17 is connected to an electromagnetic wave to electricity converter in a manner wherein electromagnetic waves received by the receiver 17 are directed to the electromagnetic wave to electricity converter to be converted to electricity. The electromagnetic wave to electricity converter is electrically connected to the electrical slots 16 such that electrical current, once converted from electromagnetic waves, is availed to the electrical slots so that any electrical device whose plug engages said slots 16 can access electrical current.

The female plug socket 14 additionally includes an AC to DC converter and a DC to AC converter disposed between the electromagnetic wave to electricity converter and the slots 16. In this manner, electrical current supplied by the electromagnetic wave to electricity converter in as alternating current or direct current. In addition, in embodiments where batteries or solar panels are used to supplement or otherwise supply electrical current to the female plug socket 14, the DC to AC converter ensures that AC current can still be provided to the slots 16.

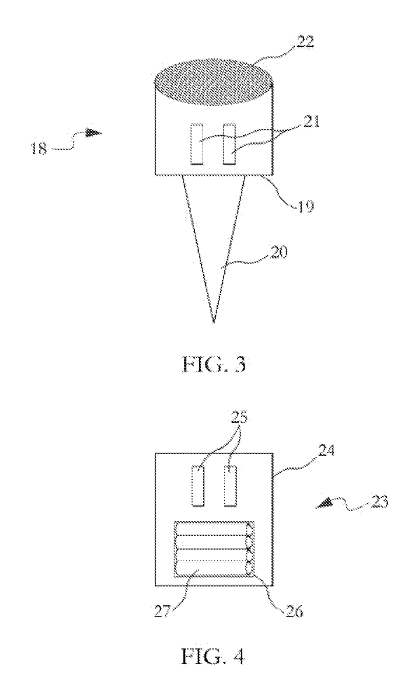

Referring now to FIG. 3, an alternate embodiment of a female plug socket 18 is shown having a water tight rigid body 19 and an attached reverse pyramid shaped base 20, a pair of electrical slots 21, and a solar panel 22. This embodiment of the female plug socket 18 is adapted to be placed outside, wherein the base 20 allows it to be driven into and secured in the ground and the solar panel 21 provides a supplementary or alternate source of electricity to be supplied to the slots 21. In such an embodiment, in addition to the components in the preferred embodiment, rechargeable batteries are also on the interior of the rigid body 19 and electrically connected to the slots 21 and the solar panel 22.

Referring now to FIG. 4, another alternate embodiment of a female plug socket 23 is shown having a rigid body 24, a pair of electrical slots 25, and a battery compartment 26. Four batteries 27 are additionally shown in the battery compartment 26. In such an embodiment, in addition to the components in the preferred embodiment, the batteries 27, typically in conjunction with the DC to AC converter, provide a supplementary or alternate source of electricity to be supplied to the slots 21. It is understood, however, that in the event that an electrical device plugged into the slots 25 requires DC electricity, any female plug socket 23 built in accordance with the present invention can be configured to provide DC current through its slots 25.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A cordless extension cord, comprising:
a male plug with a housing having electrical pins and an antenna, and with an embedded electricity to electromagnetic wave converter connected to said pins and said antenna, wherein the male plug is adapted to receive electricity from a conventional power source, convert electricity into electromagnetic waves, and broadcast electromagnetic waves;
a female plug socket with a housing having electrical slots and an electromagnetic receiver, and with an embedded electromagnetic wave to electricity converter connected to said slots and said receiver, wherein the female plug socket is adapted to convert electromagnetic waves received from the male plug into electricity and avail said electricity to the slots in a manner sufficient to provide electricity an electrical device having a cord plugged into said slots.

2. The cordless extension cord of claim 1, wherein said male pug and said female plug are disposed in rigid housings.

3. The cordless extension cord of claim 1, wherein the female plug socket additionally includes an AC to DC converter and a DC to AC converter.

4. The cordless extension cord of claim 1, wherein the female plug socket additionally includes a battery compartment adapted to received one more batteries and a DC to AC converter.

5. The cordless extension cord of claim 1, wherein the female plug socket additionally includes a DC to AC converter and a solar panel adapted to convert sunlight into electricity.

6. A cordless extension cord, comprising a female plug socket with a housing having electrical slots and at least one of a remote electrical power source and an internal electrical power source, wherein the female plug socket is adapted to avail electricity to the slots in a manner sufficient to provide electricity an electrical device having a cord plugged into said slots from the electrical power from the at least one of a remote electrical power source and an internal electrical power source.

7. The cordless extension cord of claim 6, wherein the female plug socket additionally includes an AC to DC converter and a DC to AC converter.

8. The cordless extension cord of claim 6, wherein the female plug socket additionally includes a battery compartment adapted to received one more batteries and a DC to AC converter.

9. The cordless extension cord of claim 6, wherein the female plug socket additionally includes a DC to AC converter and a solar panel adapted to convert sunlight into electricity.

10. The cordless extension cord of claim 6, wherein said female plug socket includes an electromagnetic receiver disposed on said housing and an embedded electromagnetic wave to electricity converter disposed in said house and connected to said slots and said receiver.

11. The cordless extension cord of claim 10, additionally comprising a source of electromagnetic waves remotely situated relative to said female plug socket, wherein said female plug socket is configured to convert electromagnetic waves received into electricity to be availed to the slots.

12. A cordless extension cord, comprising a male plug with a housing having electrical pins and an antenna, and with an embedded electricity to electromagnetic wave converter connected to said pins and said antenna, wherein the male plug is adapted to receive electricity from a conventional power source, convert electricity into electromagnetic waves, and broadcast electromagnetic waves.
